(19) United States
(12) Patent Application Publication
(10) Pub. No.: US 2006/0017342 A1
(43) Pub. Date: Jan. 26, 2006

(54) Rotor and compressor having the same

(75) Inventor: Jong In Park, Gwangju (KR)

Correspondence Address: LADAS & PARRY, 26 WEST 61ST STREET, NEW YORK, NY, 10023, US

(73) Assignee: SAMSUNG GWANGJU ELECTRONICS CO., LTD.

(21) Appl. No.: 11/093,313

(22) Filed: Mar. 30, 2005

(30) Foreign Application Priority Data
Jul. 20, 2004 (KR) 2004-56455

(51) Int. Cl. H02K 21/12

(52) U.S. Cl. 310/156.19

(57) ABSTRACT

A compressor having a rotor. The rotor comprises a core formed as a plurality of laminates are vertically stacked one above another and magnets provided on the outer circumference of the core. Hooks are integrally formed on the outer circumference of the core between the respective magnets in order to prevent outward separation of the magnets. For this, a respective one of the hooks includes a protruding portion extending outward from the core in a radial direction, and a support portion extending from a distal end of the protruding portion in a circumferential direction. The protruding portion serves to keep the magnets spaced apart from one another, and the support portion serves to prevent the magnets from being separated in a radial direction.

### CROSS-REFERENCE TO RELATED APPLICATION

This application claims the benefit of Korean Patent Application No. 2004-56455, filed on Jul. 20, 2004 in the Korean Intellectual Property Office, the disclosure of which is incorporated herein by reference.

### BACKGROUND OF THE INVENTION

1. Field of the Invention

The present invention relates to a compressor, and, more particularly, to a compressor having a rotor which electromagnetically interacts with a stator, that produces a magnetic field, and implements rotating motion.

2. Description of the Related Art

In general, a compressor is a device to suction a refrigerant into a hermetic space to compress it and discharge the compressed refrigerant to the outside. Such a compressor comprises a compressing unit to compress the refrigerant and a driving unit to drive the compressing unit.

The compressing unit is disposed inside a hermetic casing defining the hermetic space, and includes a cylinder block defining a compression chamber and a piston reciprocating inside the compression chamber. A cylinder head is coupled at one side of the cylinder block and is formed with a suction chamber and a discharge chamber, which communicate with the outside.

The driving unit includes a stator producing a magnetic field, a rotor adapted to implement rotating motion by electromagnetically interacting with the stator, a motor having a rotating shaft press-fitted in a hollow portion of the rotor so as to rotate simultaneously with the rotor, and a connecting rod connected to the rotating shaft and adapted to convert rotating motion into rectilinear reciprocating motion so as to move the piston forward or backward.

The rotor, in turn, includes a plurality of laminates stacked around the rotating shaft to form a core, a pair of end plates to support upper and lower ends of the core of the laminates, and magnets arranged around the core of the laminates. In order to secure the end plates to the core of the laminates, fastening members penetrate through the end plates and the core of the laminates. A cylindrical member is provided to surround the magnets in order to fixedly maintain the magnets relative to the core of the laminates.

However, the conventional compressor configured as stated above has a problem in that the cylindrical member must be present in the rotor, resulting in a complicated manufacturing process and high manufacturing cost.

The cylindrical member used to fixedly maintain the magnets, further, causes the stator, that produces magnetic flux, to be more distant from the core, resulting in deterioration in the output efficiency of the motor.

### SUMMARY OF THE INVENTION

The present invention has been made in view of the above mentioned problems, and an aspect of the invention is to provide a compressor which can permit magnets to be easily and securely affixed to a rotor and can minimize a distance between a rotor core and a stator, thereby achieving an improved output efficiency of the compressor.

In accordance with an aspect, the present invention provides a compressor comprising a rotating shaft and a rotor adapted to rotate simultaneously rotate with the rotating shaft and electromagnetically interact with a stator producing a magnetic field, wherein the rotor includes: a core formed as a stack of a plurality of laminates; a plurality of magnets arranged on an outer circumference of the core to be circumferentially spaced apart from one another; and hooks provided on the core between the respective magnets so as to prevent radial separation of the magnets.

The hooks may be integrally formed with the core.

A respective one of the hooks may include: a protruding portion extending outward from the core in a radial direction; and a support portion extending from a distal end of the protruding portion in a circumferential direction and serving to support the magnets relative to the core.

A respective one of the magnets may be formed at opposite ends thereof with coupling recesses to correspond to the support portions of the hooks so that the magnets are coupled with the hooks to define a cylindrical form.

The rotor may further include end plates provided at opposite ends of the core in order to axially support the core and the magnets.

The core and the end plates may be fixed to one another via rivets penetrating therethrough.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more easily appreciated from the following description of the embodiments, taken in conjunction with the accompanying drawings of which:

FIG. 1 is a sectional view illustrating the overall structure of a compressor in accordance with the present invention;

FIG. 2 is an exploded perspective view illustrating a rotor provided in the compressor in accordance with the present invention;

FIG. 3 is a sectional view taken along line A-A shown in FIG. 2;

FIG. 4 is a plan view of a core shown in FIG. 2; and

FIG. 5 is a plan view of magnets shown in FIG. 2.

### DETAILED DESCRIPTION OF THE PREFERRED EMBODIMENTS

Reference will now be made in detail to the embodiment of the present invention, examples of which are illustrated in the accompanying drawings, wherein like reference numerals refer to the like elements throughout.

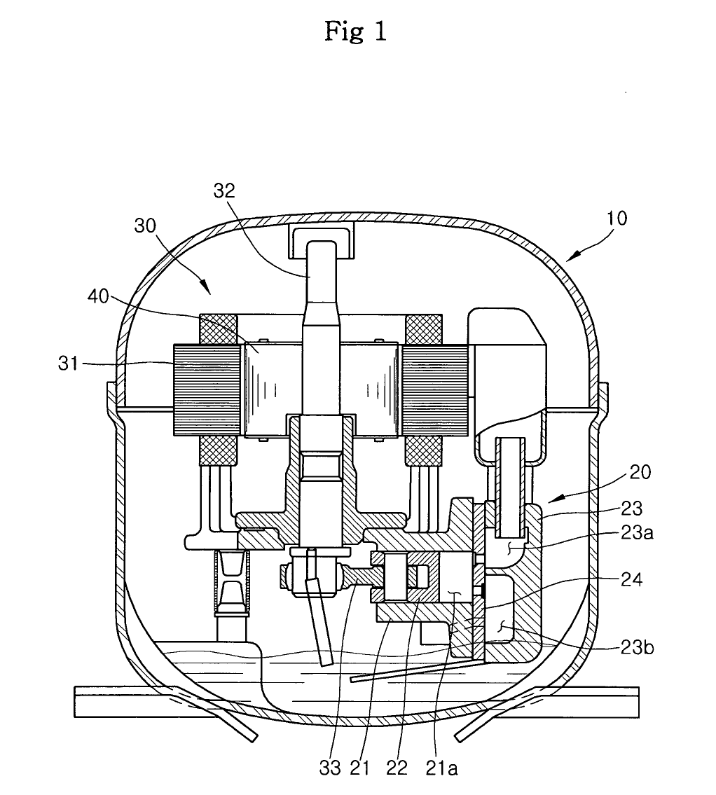

FIG. 1 is a sectional view illustrating the overall structure of a hermetic compressor in accordance with the present invention.

Referring to FIG. 1, the hermetic compressor of the present invention comprises a compressing unit 20 disposed inside a hermetic casing 10 defining a hermetic space to compress a refrigerant, and a driving unit 30 to drive the compressing unit 20.

The compressing unit 20 includes a cylinder block 21 internally defining a compression chamber 21a, and a piston 22 reciprocating inside the compression chamber 21a so as to compress the refrigerant. A cylinder head 23 is coupled to one side of the cylinder block 21. The cylinder head 23 internally defines a suction chamber 23a and a discharge chamber 23b. A valve unit 24 is interposed between the cylinder block 21 and the cylinder head 23 so as to control introduction and discharge of the refrigerant.

The driving unit 30 operates to reciprocate the piston 22, thereby permitting the refrigerant to be compressed inside the compressing unit 20. The driving unit 30 includes a stator 31 producing a magnetic field, a rotor 40 inwardly spaced apart from the stator 31 to electromagnetically interact with the stator 31, a rotating shaft 32 press-fitted in the center of the rotor 40 to rotate simultaneously with the rotor 40, and a connecting rod 33 connected to the rotating shaft 32 and adapted to convert rotating motion into rectilinear reciprocating motion so as to move the piston 22 forward or backward.

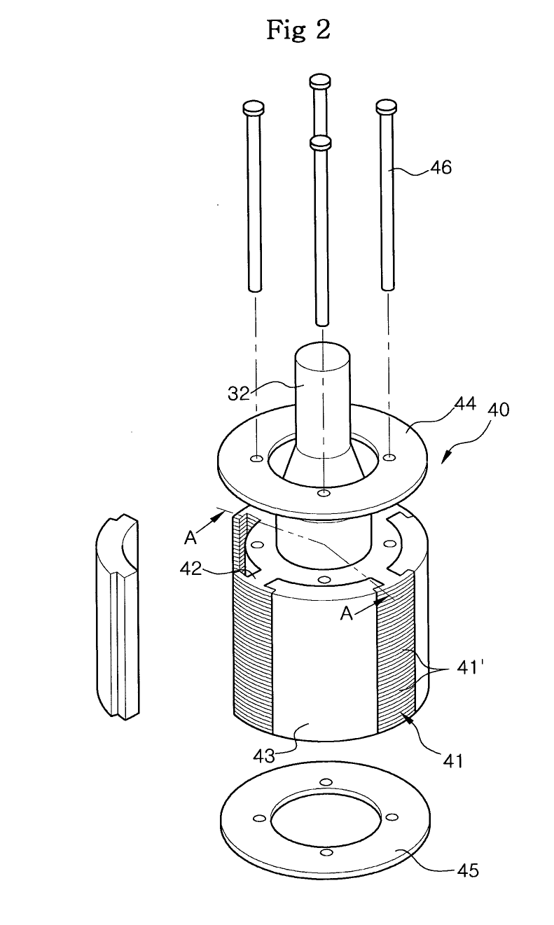

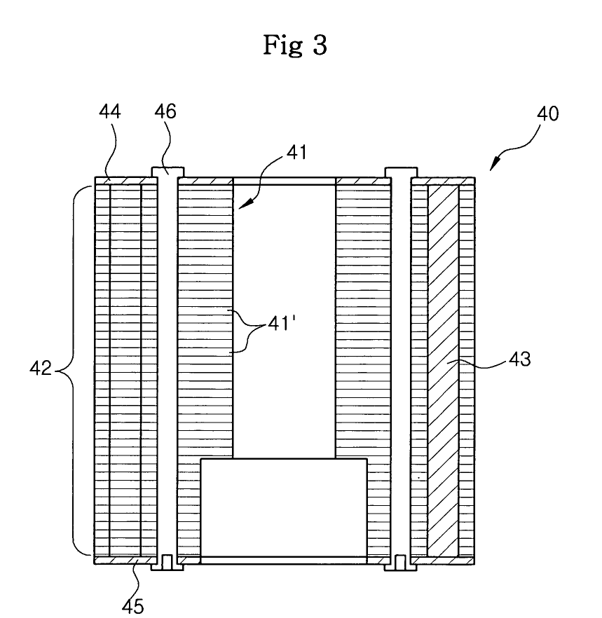

Now, the rotor 40 according to the present invention will be explained in more detail with reference to FIGS. 2 and 3. FIG. 2 is an exploded perspective view of the rotor 40 and FIG. 3 is a sectional view taken along line A-A shown in FIG. 2.

Referring to FIGS. 2 and 3, the rotor 40 according to the present invention includes a core 41 formed as a plurality of laminates 41′ are vertically stacked one above another, and magnets 43 arranged on the outer circumference of the core 41.

A plurality of the magnets 43 are arranged in alternating polarity, and are spaced apart from one another in a circumferential direction in order to avoid magnetic interference therebetween.

An upper end plate 44 and a lower end plate 45 are provided at upper and lower sides of the core 41 and are adapted to axially support the core 41 and the magnets 43. The respective laminates 41′ and the end plates 44 and 45 are fixedly maintained relative to one another via rivets 46 penetrating therethrough.

The core 41 is integrally provided at the outer circumference thereof with hooks 42. The respective hooks 42 are interposed between the respective magnets 43 in order to prevent separation of the magnets 43 in an outward direction.

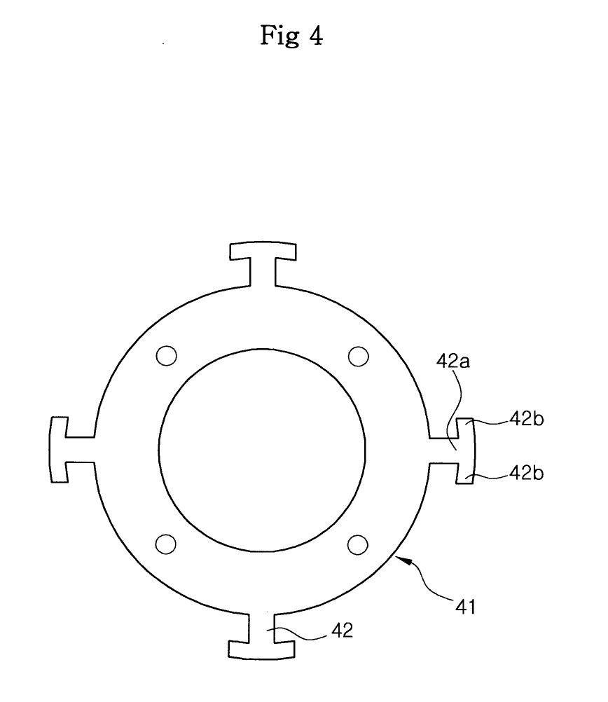

Referring to FIG. 4, a respective one of the hooks 42 has a protruding portion 42a extending outward from the core 41 in a radial direction, and a support portion 42b extending from a distal end of the protruding portion 42a in a circumferential direction. The protruding portion 42a serves to keep the magnets 43 spaced apart from one another, and the support portion 42b serves to prevent the magnets 43 from being separated in a radial direction.

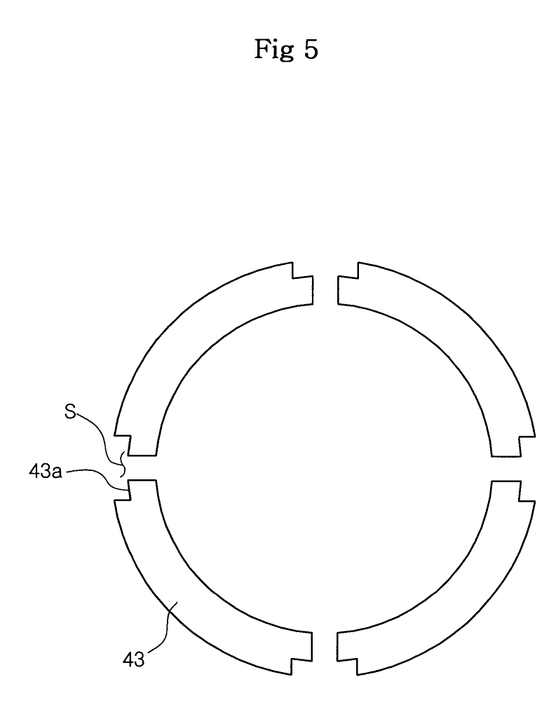

Referring to FIG. 5 illustrating the magnets 43, a respective one of the magnets 43 has coupling recesses 43a defined at opposite ends thereof, respectively, to correspond to the support portions 42b of the adjacent hooks 42. The coupling recesses 43a permit the magnets 43 to be spaced apart from one another while defining spaces S each having the same shape as that of the respective hooks 42. In this way, the magnets 43 and the hooks 42 are alternately coupled to one another to thereby define a cylindrical form.

Now, the assembly process and operational effects of the rotor 40 provided in the hermetic compressor according to the present invention will be explained.

First, the rivets 46 are successively screwed through the upper end plate 44 and the plurality of laminates 41′. Then, the magnets 43 are affixed to the outer circumference of the core 41 formed as the laminates 41′ are vertically stacked one above another. In this case, the magnets 43 are inserted in respective spaced defined between the hooks 42 and the outer circumference of the core 41 so that they are circumferentially arranged in alternating polarity.

Successively, the lower end plate 45 is fastened to the rivets 46, and then lower ends of the rivets 46 are caulked, permitting the magnets 43 to be securely affixed around the core 41.

In this way, since the magnets 43 are able to be securely affixed around the core 41 via the end plates 44 and 45 and the hooks 42, the rotor 40 of the compressor according to the present invention has no need for a separate cylindrical member used in a conventional compressor in order to fixedly surround the outer circumference of the magnets 43.

As a result, a distance between the core 41 of the rotor 40 and the stator 31 producing magnetic flux can be minimized, resulting in an improved driving efficiency of the compressor.

As is apparent from the above description, the present invention provides a compressor having a rotor in which a plurality of magnets can be securely affixed around a rotor core via hooks formed at the outer circumference of the core.

Such fixation of the magnets eliminates the need for a separate cylindrical member conventionally used to surround the outer circumference of the magnets, resulting in a reduction in the number of parts and improving productivity of the compressor.

Further, the elimination of the conventional cylindrical member has the effect of minimizing a distance between a stator and the rotor core, resulting in an improved driving efficiency of the compressor.

Although an embodiment of the present invention has been shown and described, it would be appreciated by those skilled in the art that changes may be made in this embodiment without departing from the principles and spirit of the invention, the scope of which is defined in the claims and their equivalents.

What is claimed is:

1. A compressor comprising a rotating shaft and a rotor adapted to rotate simultaneously rotate with the rotating shaft and electromagnetically interact with a stator producing a magnetic field, wherein
the rotor includes:
a core formed as a stack of a plurality of laminates;
a plurality of magnets arranged on an outer circumference of the core to be circumferentially spaced apart from one another; and
hooks provided on the core between the respective magnets so as to prevent radial separation of the magnets.

2. The compressor according to claim 1, wherein the hooks are integrally formed with the core.

3. The compressor according to claim 1, wherein a respective one of the hooks includes:
a protruding portion extending outward from the core in a radial direction; and
a support portion extending from a distal end of the protruding portion in a circumferential direction and serving to support the magnets relative to the core.

4. The compressor according to claim 3, wherein a respective one of the magnets are formed at opposite ends thereof with coupling recesses to correspond to the support portions of the hooks so that the magnets are coupled with the hooks to define a cylindrical form.

5. The compressor according to claim 1, wherein the rotor further includes end plates provided at opposite ends of the core in order to axially support the core and the magnets.

6. The compressor according to claim 5, wherein the core and the end plates are fixed to one another via rivets penetrating therethrough.

7. A rotor comprising:
a core formed as a stack of a plurality of laminates;
a plurality of magnets arranged on an outer circumference of the core to be circumferentially spaced apart from one another; and
hooks provided on the core between the respective magnets so as to prevent radial separation of the magnets.

8. The rotor according to claim 7, wherein the hooks are integrally formed with the core.

9. The rotor according to claim 7, wherein a respective one of the hooks includes:
a protruding portion extending outward from the core in a radial direction; and
a support portion extending from a distal end of the protruding portion in a circumferential direction and serving to support the magnets relative to the core.

10. The rotor according to claim 9, wherein a respective one of the magnets are formed at opposite ends thereof with coupling recesses to correspond to the support portions of the hooks so that the magnets are coupled with the hooks to define a cylindrical form.

11. The rotor according to claim 7, wherein the rotor further includes end plates provided at opposite ends of the core in order to axially support the core and the magnets.

12. The rotor according to claim 11, wherein the core and the end plates are fixed to one another via rivets penetrating therethrough.
